(19) United States
(12) Patent Application Publication
(10) Pub. No.: US 2009/0092726 A1
(43) Pub. Date: Apr. 9, 2009

(54) Method for preparing precooked frozen shellfish having extended shelf life

(76) Inventors: Darryl L. Holliday, Crowley, LA (US); Salmon L. Wright, IV, Lafayette, LA (US); Kenneth L. Venable, Crowley, LA (US)

Correspondence Address: KEAN, MILLER, HAWTHORNE, D'ARMOND,;MCCOWAN & JARMAN, L.L.P., ONE AMERICAN PLACE, 22ND FLOOR, P.O. BOX 3513, BATON ROUGE, LA, 70821, US

(21) Appl. No.: 11/973,548

(22) Filed: Oct. 9, 2007

(51) Int. Cl. A23B 4/00; A23B 4/005; A23B 4/12; A23B 4/14

(52) U.S. Cl. 426/546; 426/541

(57) ABSTRACT

A method of preparing precooked frozen shellfish, such as shrimp, crabs and crawfish having an extended shelf life. The shellfish are boiled in an aqueous cleaning solution containing an effective amount of one or more food grade acids and an antioxidant. They are then quenched in an aqueous cleaning solution containing a calcium salt, packaged, and frozen.

### CROSS REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISK

Not Applicable

### REFERENCE TO A “MICROFICHE APPENDIX”

Not Applicable

### BACKGROUND OF THE INVENTION

1. Field of the Invention

This invention relates to a method of preparing precooked frozen shellfish having an extended shelf life. Preferred shellfish include shrimp, crabs and crawfish.

2. Description of Related Art

Shellfish are an important and favorite food in many parts of the world, particularly shrimp and crabs which are saltwater shellfish. One freshwater shellfish that is becoming more and more popular is crawfish.

Louisiana has more than 30 different species of crawfish, but only two species are commercially important to the industry, the red swamp crawfish (Procambatus clarkia) and the white river crawfish (Procambatus zonangulus). Both market incentives and technological advances have expanded the Louisiana crawfish industry to include crawfish farming as well as fishing in the wild. In the 1960s, crawfish farming made its debut with the cultivation of crawfish in man-made ponds, using controlled water levels, forage management and water recalculation techniques to produce a highly marketable product.

Crawfish has been an inherent part of Louisiana culture for centuries. Every year almost 100 million pounds of crawfish are harvested, most of which is consumed in Louisiana itself. Crawfish season, which runs from about January to June in Louisiana, is an exiting time of year, with crawfish boils, backyard parties, and festivals centered around crawfish. A substantial amount of the crawfish harvest is frozen every year to provide crawfish to the consumer after fresh crawfish season has ended. But unfortunately it provides quality frozen crawfish for only few months. The most common conventional freezing method is the so-called individually quick freezing (IQF) method. However, the texture of the meat becomes mealy and grainy after being frozen for about three to four months, even when frozen by IQF methods. Therefore, there is a need in the art for methods to increase the shelf life of frozen shellfish.

### BRIEF SUMMARY OF THE INVENTION

In accordance with the present invention there is provided a process for preparing frozen shellfish having extended shelf life, which process comprises:

a) preparing an aqueous mixture comprised of: i) water, ii) an effective amount of one or more food grade acids to result in a pH of the mixture of about 3.7 to about 4.2, iii) an effective amount of a food grade antioxidant, and iv) an effective amount of sodium alginate;

b) boiling said aqueous mixture thereby resulting in a hot aqueous mixture;

c) introducing a predetermined amount of shellfish into said hot aqueous mixture;

d) keeping said predetermined amount of shellfish in said hot aqueous mixture for a predetermined amount of time resulting in cooked shellfish;

e) removing said cooked shellfish from said hot aqueous mixture;

f) placing said cooked shellfish in an aqueous bath comprised of water and an effective amount of one or more calcium salts for an effective amount of time, which calcium salts are soluble or miscible in said aqueous bath;

g) removing said cooked shellfish from said aqueous bath after the effective amount of time; and

h) freezing said shellfish removed from said aqueous bath.

In a preferred embodiment, an effective amount of vegetable oil is used in the aqueous mixture.

In another preferred embodiment the shellfish are selected from the group consisting of crabs, shrimp and crawfish.

### DETAILED DESCRIPTION OF THE INVENTION INCLUDING BEST MODE

The present invention relates to a method for more effectively freezing precooked shellfish, particularly shrimp, crabs, and crawfish so that they have a shelf life substantially greater than frozen shellfish processed by conventional methods. Pre-boiled frozen shellfish currently have a shelf life of only about three to four months primarily because of the degradation and denaturization of the meat during frozen storage. Denaturization is a process that proteins undergo when they are subjected to stresses that will affect the structure of the molecule which leads to a loss in some of its properties. Therefore, this short shelf life limits any production of frozen crawfish on a large scale for purposes of retail and food service distribution year round. Because of the growth of the seafood industry and because of greater demand for seafood itself, there is an increasing need to transport seafood products worldwide. Although moving fresh product is still practiced globally, transporting them in frozen form is becoming a more efficient way to transport this commodity. Although any freezing method can be used in the practice of the present invention an IQF (individually quick frozen) method is preferred. The preferred temperature for freezing the shellfish ranges from about −20° F. and −50° F. The preferred freezing time ranges between about 5 minutes to one hour. In a conventional fluid bed freezer, the freezing time and rate are dependent on airflow and air temperatures, as well as the shellfish being frozen. In the alternative, a forced air freezer can be used that has air temperatures as low as −50° F., with high airflows creating IQF pieces in about 5 to 10 minutes. Liquid immersion freezers can also be used. The immersion freezer contacts the product to be frozen with a refrigerant solution (i.e. Liquid Nitrogen, etc.), which freezes the product almost instantaneously. Although such freezing methods of have met with great success, food products such as crawfish suffer from a relatively short shelf life when frozen, even by IQF methods.

The present invention is generally practiced by treating the shellfish in a multi-step process. In a first step, an aqueous mixture, sometimes referred to herein as a cleaning/cooking agent, is prepared. It will be understood the term “mixture” as used herein can include both a solution and slurry. This aqueous mixture is comprised of an effective amount of water, an effective amount of one or more food grade acids, an effective amount of a food grade antioxidant, and optionally an effective amount of a vegetable oil. By effective amount of vegetable oil we mean at least that minimum amount needed to aid in binding seasoning to the cooked shellfish and that will enhance the peeling of the shell from the meat. This effective amount will be from about 1 to 10 vol. %, preferably about 2 to 5 vol. % based on the amount of water used. Non-limiting examples of vegetable oils suitable for use in the present invention include soybean oil, palm oil, rapeseed oil, sunflower oil, corn oil, peanut oil, cottonseed oil, olive oil, hazelnut oil, linseed oil, rice bran oil, safflower oil, and sesame oil. Preferred are soybean oil, peanut oil, sunflower oil and corn oil.

By effective amount of water we mean that amount of water needed to boil, and cook to satisfaction, the amount of shellfish being processed by the present invention. By effective amount of food grade acids we mean that amount needed, given the amount of water, to result in a pH of about 3.4 to about 4.5, preferably from about 3.7 to about 4.2. Non-limiting examples of preferred food grade acids that can be used in the practice of the present invention include citric acid, ascorbic acid, tartaric acid, lactic acid, malic acid, fumaric acid, and acetic acid. More preferred are ascorbic acid and citric acid. Non-liming examples of preferred food grade antioxidants include butylated hydroxytoluene, mineral ascorbates, and nutraceuticals. By effective amount of food grade antioxidant we mean that amount needed to achieve the antioxidant function of the aqueous mixture. Typically, such an effective amount will be from about 1% to about 5%, preferably from about 1% to about 2% Nutraceuticals are any natural, bio-active chemical compound that has health promoting, disease preventing or medicinal properties. Non-limiting examples of nutraceuticals include herbs, amino acids, minerals, and vitamins. Preferred nutraceuticals for use in the present invention include capsaicin, rosemary extract, lycopene, apple carotenoids, citosan, and parsley extract.

The aqueous mixture is brought to a boil and a predetermined amount of shellfish are introduced into the boiling solution. The shellfish are kept in the hot solution, either boiling or within a temperature just below boiling, until the shellfish are cooked to satisfaction. After the shellfish are cooked to satisfaction they are removed from the hot aqueous mixture and placed, for an effective amount of time, into an aqueous quenching bath. The aqueous quenching bath is preferably at a temperature from about 60° F. to 90° F., more preferably from about 65° F. to about 75° F. (room temperature) and is comprised of water and an effective amount of one or more calcium salts that are either water miscible or water soluble. An effective amount of time will be at least that minimum amount of time needed for the calcium salt to come into contact with the sodium alginate to form a gel. Such an amount of time will be from about 20 seconds to about 2 minutes, preferably from about 30 seconds to about 1 minute. It is preferred that one or more calcium salts be water soluble. Non-limiting examples of calcium salts suitable for use in the present invention include calcium carbonate, calcium phosphate, e.g., calcium monophate, calcium diphosphate, calcium triphosphate, calcium ascorbate, calcium chloride, calcium citrate, calcium gluconate, calcium glycerophosphate, calcium maleate, calcium hydrogen maleate, calcium lactate, and calcium oxide. Preferred are calcium lactate, calcium citrate, calcium ascorbate and calcium chloride.

After the shellfish have been in the quenching bath for an effective amount of time they can be either frozen directly or seasoned, then frozen. If they are seasoned then any suitable food grade seasoning can be used. Nonlimiting examples of seasonings that can be used in the practice of the present invention include water-soluble sugars or sugar substitutes, black pepper, cayenne pepper, celery seed powder, garlic powder, paprika, and a sodium chloride salt. Suitable water-soluble sugars and/or sugar substitutes are glucose, maltose, sucrose, dextrose, fructose, sorbitol, mannitol or other types of natural or artificial sweeteners. If the shellfish are crawfish cayenne pepper is one preferred seasoning ingredient.

The present invention can better be understood with reference to the example presented below. This example is presented only as an illustration of the present invention and is not to be taken as being limiting in anyway.

### EXAMPLE

60 lbs of crawfish were boiled in an aqueous mixture (cleaning/cooking solution) of 11 gallons of water, 1 lb of cleaning agent, 4 cups of vegetable oil, 23 grams of BHT (butylated hydroxytoluene) of 25% purity, and 114.5 grams of sodium alginate. The cleaning agent was comprised of 77.51 grams of ascorbic acid, 150.62 lbs of citric acid, and 228.25 grams of sodium ascorabate. The crawfish were cooked for about 5 minutes. The boiled crawfish were then removed from the hot aqueous mixture and dipped, for an effective amount of time, into a cooling dip (quench bath) comprised of 11 gallons of water and 100 grams of calcium lactate. The temperature of the quench bath was about room temperature. After about 30 seconds they were then removed from the quench bath and gently tossed with 645 grams of seasoning comprised of 50% granulated extra fine sugar, 12.5 wt. % cayenne pepper, 12.5 wt. % celery seed powder, 12.5 wt. % garlic powder, 6.25 wt. % paprika, and 6.25 wt. % iodized salt.

The mixture of water, oil, and cleaning agent had a pH of 4.08. The water is used to transfer heat for cooking and also to transfer the cleaning ingredients. The oil is useful for binding the seasoning to the cooked meat and will allow for easier peeling of the tail meat from the shell. The cleaning agent helps scrub the crawfish shells of any remaining dirt or grime and softens the shell as the crawfish cook. This mixture is then brought to a boil which resulted in a lower pH of about 3.8 to help activate the cleaning solution. The sodium alginate is deposited onto the meat while it is cooking and will form a gel when in contact with the calcium lactate. It is preferred to add the sodium alginate and BHT after the crawfish are added to the boiling aqueous mixture. The cooked and seasoned crawfish are then packaged and frozen.

What is claimed is:

1. A process for preparing frozen shellfish having extended shelf life, which process comprises:
a) preparing an aqueous mixture comprised of: i) water, ii) an effective amount of one or more food grade acids to result in a pH of the mixture of about 3.4 to about 4.5, iii) an effective amount of a food grade antioxidant, and iv) an effective amount of sodium alginate;
b) boiling said aqueous mixture thereby resulting in a hot aqueous mixture;
c) introducing a predetermined amount of shellfish into said hot aqueous mixture;
d) keeping said predetermined amount of shellfish in said hot aqueous mixture for a predetermined amount of time resulting in cooked shellfish;
e) removing said cooked shellfish from said hot aqueous mixture;
f) placing said cooked shellfish in an aqueous bath comprised of water and an effective amount of one or more calcium salts for an effective amount of time, which calcium salts are soluble or miscible in said aqueous bath;
g) removing said cooked shellfish from said aqueous bath after the effective amount of time; and
h) freezing said shellfish removed from said aqueous bath.

2. The process of claim 1 wherein an effective amount of vegetable oil is also present in the aqueous mixture.

3. The process of claim 2 wherein the vegetable oil is selected from the group consisting of soybean oil, palm oil, rapeseed oil, sunflower oil, corn oil, peanut oil, cottonseed oil, olive oil, hazelnut oil, linseed oil, rice bran oil, safflower oil, and sesame oil.

4. The process of claim 1 wherein the food grade acid is selected from the group consisting of citric acid, ascorbic acid, tartaric acid, lactic acid, malic acid, fumaric acid, and acetic acid.

5. The process of claim 4 wherein the food grade acid is selected from ascorbic acid and citric acid.

6. The process of claim 1 wherein the antioxidant is selected from the group consisting of butylated hydroxytoluene, mineral ascorbates, and nutraceuticals.

7. The process of claim 6 wherein the antioxidant is a mineral ascorbate selected from the group consisting of sodium ascorbate, calcium ascorbate, potassium ascorbate and magnesium ascorbate.

8. The process of claim 1 wherein the hot aqueous mixture is boiling when the shellfish are placed in it.

9. The process of claim 1 wherein the hot aqueous mixture is at a temperature of about 200° F. to about 210° F. when the shellfish are placed in it.

10. The process of claim 1 wherein the aqueous quenching bath is at a temperature from about 60° F. to 90° F.

11. The process of claim 10 wherein the aqueous quenching bath is at a temperature from about 65° to 75° F.

12. The process of claim 1 wherein the one or more calcium salts are selected from the group consisting of calcium carbonate, calcium monophate, calcium diphosphate, calcium triphosphate, calcium ascorbate, calcium chloride, calcium citrate, calcium gluconate, calcium glycerophosphate, calcium maleate, calcium hydrogen maleate, calcium lactate, and calcium oxide.

13. The process of claim 12 wherein the one or more calcium salts are selected from the group consisting of calcium lactate, calcium citrate, calcium ascorbate and calcium chloride.

14. The process of claim 1 wherein the shellfish are frozen by the IQF method.

15. The process of claim 2 wherein the antioxidant is selected from the group consisting of butylated hydroxytoluene, mineral ascorbates; the food grade acid is selected from the group consisting of citric acid, ascorbic acid, tartaric acid, lactic acid, malic acid, fumaric acid, and acetic acid; and the

16. The process of claim 15 wherein the one or more calcium salts is selected from the group consisting of calcium carbonate, calcium monophate, calcium diphosphate, calcium triphosphate, calcium ascorbate, calcium chloride, calcium citrate, calcium gluconate, calcium glycerophosphate, calcium maleate, calcium hydrogen maleate, calcium lactate, and calcium oxide.

17. The process of claim 1 wherein the shellfish are treated with an effective amount of seasoning after removal from the aqueous bath but before being frozen, which seasoning comprises a preservative component.

18. The process of claim 17 wherein the seasoning contains at least one ingredient selected from the group consisting of a water-soluble sugar or sugar substitute, black pepper, cayenne pepper, celery seed powder, garlic powder, paprika, and a sodium chloride salt.

19. The process of claim 16 wherein the shellfish are treated with an effective amount of seasoning after removal from the aqueous bath but before being frozen, which seasoning is selected from the group consisting of a water-soluble sugar or sugar substitute, black pepper, cayenne pepper, celery seed powder, garlic powder, paprika, and a sodium chloride salt.

20. The process of claim 1 wherein an effective amount of nutraceutical is present, which nutraceutical is selected from the group consisting of herbs, amino acids, minerals, and vitamins.

21. The process of claim 19 wherein an effective amount of nutraceutical is present, which nutraceutical is selected from the group consisting of herbs, amino acids, minerals, and vitamins.
